(19) United States
(12) Patent Application Publication
(10) Pub. No.: US 2012/0109684 A1
(43) Pub. Date: May 3, 2012

(54) METHOD AND SYSTEM FOR COMPARING MEDICAL SERVICES

(75) Inventors: Chittaranjan Mallipeddi, San Jose, CA (US); David Clinton Koch, Aptos, CA (US); Sreeram Bonde, Dallas, TX (US)

(73) Assignee: General Electric Company, Schenectady, NY (US)

(21) Appl. No.: 12/913,328

(22) Filed: Oct. 27, 2010

(51) Int. Cl. G06Q 50/00; G06Q 10/00

(52) U.S. Cl. 705/3

(57) ABSTRACT

A method for comparing medical services provided by a plurality of healthcare entities includes creating a performance criterion that is associated with the medical services provided to patients by first and second healthcare entities and using a processor to determine first and second compliance indices by comparing the performance criterion to first and second sets of electronic health records (EHRs) of the patients that are maintained by the first and second healthcare entities, respectively. The first and second compliance indices represent quantities of the patients having medical data in the first and second sets of EHRs that satisfies the performance criterion. The method also includes presenting the first and second compliance indices associated with the first and second healthcare entities to a user.

### BACKGROUND OF THE INVENTION

The subject matter disclosed herein relates generally to methods and systems for comparing services of different entities that provide the services, and more particularly for comparing medical services provided by different healthcare entities.

A variety of healthcare entities provide medical services, including independent physicians, independent physician associations formed of several independent physicians, clinical practice groups that include several physicians working together, hospitals, and the like. The healthcare entities provide medical services to patients according to medical guidelines or recommendations. The guidelines may be created by the entities or by third party industry groups, such as the American Medical Association, and the American Diabetes Association. Additionally, guidelines may be created by healthcare insurance plans. The guidelines may provide recommendations or requirements relating to the type of medical services provided to patients and the frequency at which medical services are provided to patients. For example, the guidelines may dictate what types of medical tests are applied on a subset of a patient population and/or the frequency at which the medical tests are applied.

The healthcare entities attempt to provide services to the patients according to the guidelines. As one example, a guideline may recommend that all male patients who are at least 50 years old should receive a colonoscopy at least once every ten years. Due to human error, clerical error, or oversight, however, some patients may not receive medical services according to the guidelines. For example, not all male patients who are at least 50 years old receive the colonoscopy every decade.

The healthcare entities may be unaware that some patients may not be receiving medical care according to the guidelines. When the patients do not receive medical services according to the guidelines, the patients and the healthcare entities suffer. For example, the patients do not receive the recommended medical care and the healthcare entities lose out on the revenue generated by providing the medical services recommended by the guidelines.

Moreover, the guidelines may be periodically updated or revised. The healthcare entities may be unaware of the updates to the guidelines for a significant period of time. Consequently, the patients of the healthcare entities may not receive medical care according to the most recent guidelines and the healthcare entities lose out on the revenue that would be generated by providing the medical services according to the updated guidelines.

### BRIEF DESCRIPTION OF THE INVENTION

In accordance with one embodiment, a method for comparing medical services provided by a plurality of healthcare entities is disclosed. The method includes creating a performance criterion that is associated with the medical services provided to patients by first and second healthcare entities and using a processor to determine first and second compliance indices by comparing the performance criterion to first and second sets of electronic health records (EHRs) of the patients that are maintained by the first and second healthcare entities, respectively. The first and second compliance indices represent quantities of the patients having medical data in the first and second sets of EHRs that satisfies the performance criterion. The method also includes presenting the first and second compliance indices associated with the first and second healthcare entities to a user.

In another embodiment, a system for comparing medical services provided by a plurality of healthcare entities is disclosed. The system includes a guideline management module, a compliance module, and a reporting module. The guideline management module creates a performance criterion that is associated with the medical services provided to patients by first and second healthcare entities. The compliance module receives the performance criterion from the guideline management module, the compliance module determining first and second compliance indices by comparing the performance criterion to first and second sets of electronic health records (EHRs) of the patients that are maintained by the first and second healthcare entities, respectively. The first and second compliance indices represent quantities of the patients having medical data in the first and second sets of EHRs that satisfies the performance criterion. The reporting module receives the first and second compliance indices associated with the first and second healthcare entities from the compliance module and presents the first and second compliance indices to a user.

In another embodiment, a tangible and non-transitory computer readable storage medium is disclosed for a system that that compares medical services provided by a plurality of healthcare entities. The computer readable storage medium includes instructions to direct a processor of the system to create a performance criterion that is associated with the medical services provided to patients by first and second healthcare entities and determine first and second compliance indices by comparing the performance criterion to first and second sets of electronic health records (EHRs) of the patients that are maintained by the first and second healthcare entities, respectively. The first and second compliance indices represent quantities of the patients having medical data in the first and second sets of EHRs that satisfies the performance criterion. The instructions also direct the processor to present the first and second compliance indices to a user.

### BRIEF DESCRIPTION OF THE DRAWINGS

FIG. 1 is a block diagram of a services comparison system in accordance with one embodiment.

FIG. 2 is an illustration of the services comparison system shown in FIG. 1 communicating with two healthcare entities in accordance with one embodiment.

FIG. 3 illustrates a flowchart for a method of comparing medical services provided by the different healthcare entities shown in FIG. 2 in accordance with one embodiment.

### DETAILED DESCRIPTION OF THE INVENTION

The foregoing summary, as well as the following detailed description will be better understood when read in conjunction with the appended drawings. To the extent that the figures illustrate diagrams of the functional blocks of various embodiments of the disclosed subject matter, the functional blocks are not necessarily indicative of the division between hardware circuitry. Thus, for example, one or more of the functional blocks (for example, processors or memories) may be implemented in a single piece of hardware (for example, a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments of the disclosed subject matter are not limited to the arrangements and instrumentality shown in the drawings.

As used herein, an element or step recited in the singular and proceeded with the word “a” or “an” should be understood as not excluding plural of the elements, steps, or operations, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

One or more embodiments of the subject matter described herein provide a system and method for comparing medical services provided by different healthcare entities, such as individual physicians, groups of physicians, medical practice groups, hospitals, groups of hospitals, health insurance plans, and the like. The scope of the subject matter is not, however, limited to healthcare entities. The subject matter described herein may be applicable to other entities that provide services to customers. In accordance with one embodiment, a system and method provides performance criteria that is compared to electronic health records (EHRs) of several patients that receive medical care from the healthcare entities. The comparison of the performance criteria to the EHRs provides compliance indices that may represent how closely the healthcare entities are following or providing services in accordance with the performance criteria. The compliance indices associated with the different healthcare entities may be compared with each other to provide a relatively easy comparison between the different healthcare entities. For example, a first healthcare entity may be able to compare the services being provided to the patients of the first healthcare entity to the services provided by a second healthcare entity and determine if the first healthcare entity should be providing more or different medical services.

The performance criteria may be periodically updated and pushed, or automatically sent, to the different healthcare entities so that the compliance indices may be updated as medical standards change. Based on the compliance indices, a recommendation may be generated and provided to one or more of the healthcare entities that recommends providing different or additional medical services to the patients. One technical effect disclosed herein is the ability to more easily compare the services provided by different healthcare entities. Another technical effect is the ability to update performance criteria so that changing medical standards may be automatically updated and used to compare the services provided by different healthcare entities.

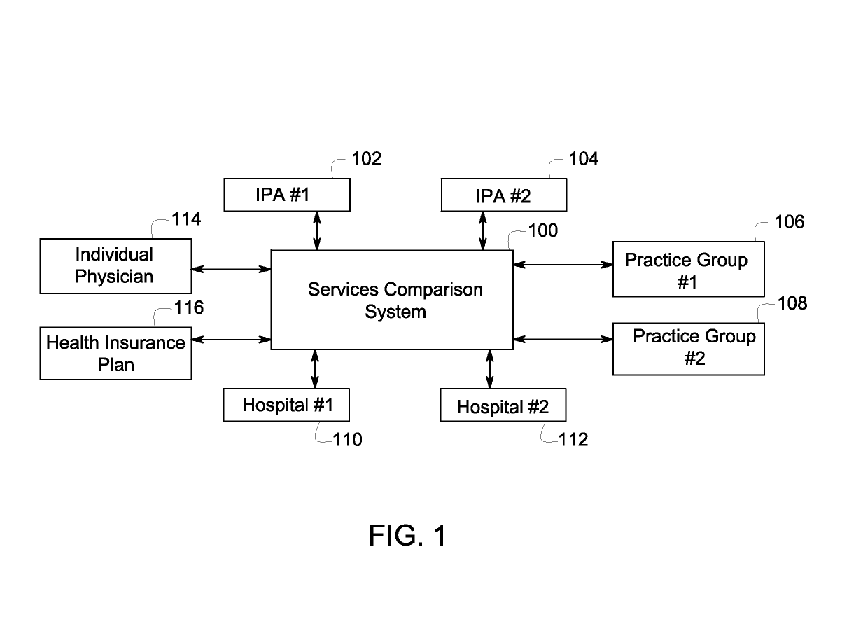

FIG. 1 is a diagram of a services comparison system 100 in accordance with one embodiment. The services comparison system 100 is a system that compares medical services provided by several healthcare entities 102, 104, 106, 108, 110, 112, 114, 116 so that different ones of the healthcare entities 102, 104, 106, 108, 110, 112, 114, 116 or subsets of the healthcare entities 102, 104, 106, 108, 110, 112, 114, 116 can easily compare the respective practices with one another. The healthcare entities 102, 104, 106, 108, 110, 112, 114, 116 include different persons, companies, groups, and the like, that provide medical or clinical services to patients. For example, two or more of the healthcare entities 102, 104, 106, 108, 110, 112, 114, 116 may be located in different and separate buildings, structures, cities, counties, states, countries, and the like.

In the illustrated embodiment, the healthcare entities 102, 104, 106, 108, 110, 112, 114, 116 include independent physician associations 102, 104 (“IPA #1” and “IPA #2”), practice groups 106, 108 (“Practice Group #1” and “Practice Group #2”), hospitals 110, 112 (“Hospital #1” and “Hospital #2”), an individual physician 114, and a health insurance plan 116. Alternatively, one or more of the healthcare entities 102, 104, 106, 108, 110, 112, 114, 116 may include a group of IPAs, practice groups, hospitals, and/or health insurance plans.

The IPAs 102, 104 include independent physicians or healthcare providers that do not work for or are associated with a larger healthcare entity, such as the hospitals 110, 112. For example, the IPAs 102, 104 may be formed from independent physicians that have joined together to provide a network or group of multiple medical specialties.

The practice groups 106, 108 include non-person entities that provide healthcare services. For example, the practice groups 106, 108 may be corporate or other non-person entities that hire or employ physicians to provide medical services to patients. The practice groups 106, 108 may be different groups of physicians that specialize in particular medical fields, such as endocrinology, pediatrics, oncology, and the like. The practice groups 106, 108 may be separate from the hospitals 110, 112.

The hospitals 110, 112 include larger medical institutions or non-person entities that provide healthcare services. The hospitals 110, 112 may include several practice groups 106, 108 and/or individual physicians 114 that work with or are employed by the hospitals 110, 112.

The individual physician 114 represents an individual person that provides healthcare services. For example, the individual physician 114 may be a single physician that provides medical services and that is not associated with a group of physicians through the IPAs 102, 104, the practice groups 106, 108, or the hospitals 110, 112. Alternatively, the individual physician 114 may be a single physician that is part of one or more of the IPAs 102, 104, the practice groups 106, 108, or the hospitals 110, 112.

The health insurance plan 116 includes a person or entity that provides or pays for the expenses of medical care provided to another person.

In one embodiment, the services comparison system 100 provides performance criteria to the healthcare entities 102, 104, 106, 108, 110, 112, 114, 116. The performance criteria include medical standards or guidelines that can be compared to the services provided by the healthcare entities 102, 104, 106, 108, 110, 112, 114, 116 to determine if the patients of the healthcare entities 102, 104, 106, 108, 110, 112, 114, 116 are receiving proper or adequate medical care. The performance criteria may be created by the services comparison system 100 and/or by a third party entity.

The performance criteria may represent a frequency at which one or more medical tests are to be provided to a set or group of patients of the healthcare entities 102, 104, 106, 108, 110, 112, 114, 116. By way of example only, a performance criterion may include a guideline requiring that all male patients that are at least 50 years old receive a colonoscopy examination at least once every ten years. As another example, a performance criterion may include a guideline requiring that all type 1 diabetics receive a hemoglobin A1c test at least once every three months. In another example, a performance criterion may include a guideline requiring all patients, regardless of age or gender, receive a physical examination at least once every year.

The performance criteria may represent a frequency at which one or more medical services are provided to a set or group of patients of the healthcare entities 102, 104, 106, 108, 110, 112, 114, 116. By way of example only, a performance criterion may include a guideline requiring that all patients having a particular allergy receive immunotherapy according to a predetermined schedule.

The performance criteria may represent a result of a medical test provided to a patient by the healthcare entities 102, 104, 106, 108, 110, 112, 114, 116. For example, the performance criteria may be a guideline of acceptable ranges for the result of a medical test. By way of example only, the performance guideline may set forth a range of acceptable low-density lipoprotein (LDL) levels measured from a patient's cholesterol test; a range of acceptable weights for a patient based on the patient's age, gender, and other factors; a blood oxygen content of a patient, and the like.

The performance criteria are compared to medical data recorded in EHRs associated with the patients of the healthcare entities 102, 104, 106, 108, 110, 112, 114, 116. The performance criteria are compared to the EHRs to generate compliance indices associated with the different healthcare entities 102, 104, 106, 108, 110, 112, 114, 116. The compliance indices provide comparable measures of the services provided by the healthcare entities 102, 104, 106, 108, 110, 112, 114, 116. For example, the compliance indices may represent quantifiable measurements of how the services provided by the healthcare entities 102, 104, 106, 108, 110, 112, 114, 116 follow, abide by, or otherwise comply with the performance criteria. The compliance indices for different healthcare entities 102, 104, 106, 108, 110, 112, 114, 116 may be used to compare the services provided by the healthcare entities 102, 104, 106, 108, 110, 112, 114, 116. The compliance indices may be used to recommend additional or different medical services, tests, examinations, and the like for one or more of the healthcare entities 102, 104, 106, 108, 110, 112, 114, 116, as described below.

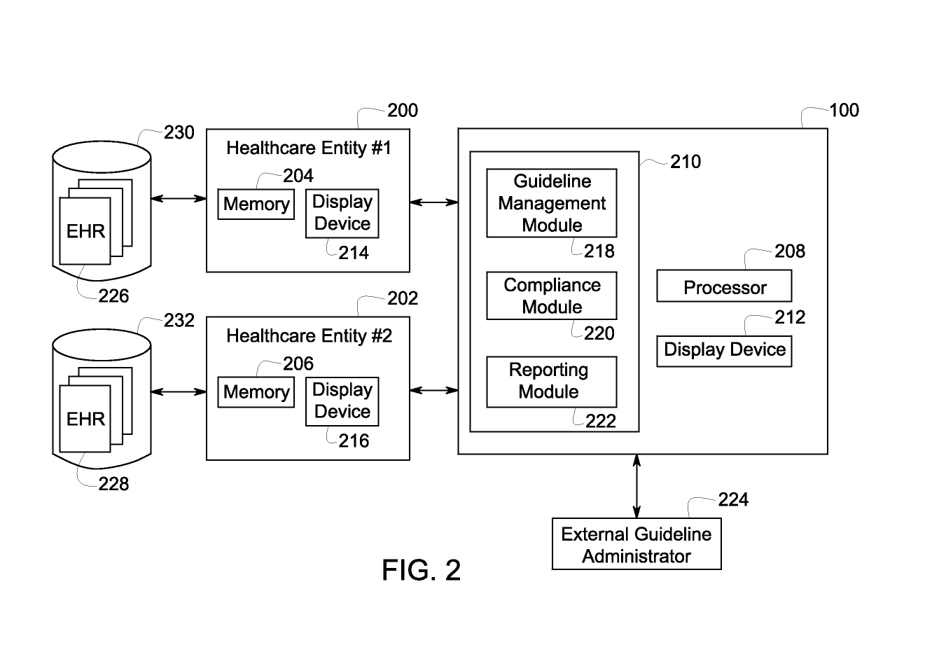

FIG. 2 is an illustration of the services comparison system 100 communicating with two healthcare entities 200, 202 in accordance with one embodiment. The healthcare entities 200, 202 (“Healthcare Entity #1” and “Healthcare Entity #2”) represent two of the healthcare entities 102, 104, 106, 108, 110, 112, 114, 116 shown and described above in connection with FIG. 1. The number of healthcare entities 200, 202 shown in FIG. 2 is merely an example. A different number of healthcare entities 200, 202 may be provided. The services comparison system 100 may be remote from one or more of the healthcare entities 200, 202. For example, the services comparison system 100 may be located in a different building, street, city, county, state, or country that one or more of the healthcare entities 200, 202.

The services comparison system 100 communicates with the healthcare entities 200, 202 using wired and/or wireless connections, such as one or more networks. By way of example only, the services comparison system 100 may communicate with the healthcare entities 200, 202 over one or more of the Internet, an internet, an intranet, a Local Area Network (LAN), or a Wide Area Network (WAN). In one embodiment, the services comparison system 100 communicates with the healthcare entities 200, 202 using a light client, or a Software-As-A-Service (SaaS) software that is installed on tangible and non-transitory computer readable storage media, or memories 204, 206, of the healthcare entities 200, 202.

The services comparison system 100 includes a processor 208 and a tangible and non-transitory computer readable storage medium, such as a memory 210. The memories 204, 206, 210 may be provided as one or more computer disc drives, flash drives, ROM drives, RAM drives, servers, and the like. The processor 208 may be a computer processor, microprocessor, controller, microcontroller, or other logic device that performs operations based on computer-readable instructions stored on the memory 210. In one embodiment, the services comparison system 100 includes a display device 212, such as a computer monitor, printer, and the like, that visually presents information to a user of the services comparison system 100. The healthcare entities 200, 202 also may include display devices 214, 216 that visually present information to users at the healthcare entities 200, 202.

The memory 210 includes several modules 218, 220, 222 that direct the processor 208 to perform various functions. The modules 218, 220, 222 described herein may be separate software programs or packages, or may be collectively provided in one or more software programs or packages. A guideline management module 218 creates the performance criteria that are associated with medical services provided to patients by the healthcare entities 200, 202. For example, if the external guideline administrator 224 recommends that all type 1 diabetic patients receive an eye examination at least once a year, the guideline management module 218 may create a performance criteria that requires type 1 diabetic patients of the healthcare entities 200, 202 to receive yearly eye examinations. The guideline management module 218 may create the performance criteria by writing a logical set of rules that are based on the guidelines. The rules are compared to the medical data of the healthcare entities 200, 202 that is associated with the patients of the healthcare entities 200, 202 in order to determine if the medical data satisfies or meets the requirements of the rules and guidelines.

The guideline management module 218 may create the performance criteria based on guidelines or standards that are established by a third party, such as an external guideline administrator 224. The external guideline administrator 224 may include an industry or trade group such as the American Medical Association, the American Diabetes Association, the American Heart Association, the American Cancer Society, and the like. Alternatively, the external guideline administrator 224 may include one or more of the healthcare entities 102, 104, 106, 108, 110, 112, 114, 116 (shown in FIG. 1).

A compliance module 220 compares the performance criterion to medical data of the patients receiving medical services from the healthcare entities 200, 202. The healthcare entities 200, 202 may maintain EHRs 226, 228 that record medical data of the patients of the healthcare entities 200, 202. The medical data may include demographic information about the patient such as age, weight, and gender, as well as information regarding medical conditions of the patient, medical tests and services performed on the patient, results of the medical tests, health insurance of the patient, and the like.

The healthcare entities 200, 202 may have separate databases 230, 232 that store the EHRs 226, 228 associated with the patients that separately receive medical care from the healthcare entities 200, 202. Alternatively, the healthcare entities 200, 202 may store the EHRs 226, 228 for the patients in a common database that is shared by the healthcare entities 200, 202. In another embodiment, the EHRs 226, 228 associated with the patients of the healthcare entities 200, 202 may be stored by the services comparison system 100. For example, the services comparison system 100 may include one or more databases that store the EHRs 226, 228 of the healthcare entities 200, 202.

The compliance module 220 determines compliance indices for the healthcare entities 200, 202 based on the comparison of the performance criterion to the EHRs 226, 228. In one embodiment, the compliance indices represent quantities of the patients having medical data in the EHRs 226, 228 that satisfy the performance criterion. For example, if the performance criterion requires that all female patients aged 40 years and older receive a mammogram examination once a year, the compliance module 220 may search the EHRs 226, 228 for female patients that are at least 40 years old. Once the compliance module 220 has identified the EHRs 226, 228 of these patients, the compliance module 220 examines the medical data stored in the EHRs 226, 228 of these patients to determine how many of the patients have medical data indicating that the patients have received a mammogram examination in the previous year. For example, the compliance module 220 may count the number of the patients that received a mammogram examination from the healthcare entity 200, 202 within the previous year. The number of female patients of the healthcare entity 200 that are 40 years or older and have received a mammogram examination within the previous year may be the compliance index for the healthcare entity 200. The number of female patients of the healthcare entity 202 that are 40 years or older and have received a mammogram examination within the previous year may be the compliance index for the healthcare entity 202. Alternatively, a different number or calculation may be performed based on a comparison of the performance criterion and the data recorded in the EHRs 226, 228.

Alternatively or in addition to determining the number of patients that satisfy the performance criterion, the compliance module 220 may calculate the number of qualified patients that do not satisfy the performance criterion. A qualified patient is a patient to whom the performance criterion applies. For example, the performance criterion that requires women aged 40 years and older receive yearly mammogram examinations applies to women that are 40 years and older, but does not apply to men and women who are younger than 40 years old. The compliance module 220 may count the number of qualified patients that do not satisfy the applicable performance criterion. For example, the compliance module 220 may determine the number of women who are 40 years or older and that have not receive a mammogram examination within the previous year. The number of qualified patients that do not satisfy the performance criterion may be the compliance index calculated for the healthcare entity 200, 202 associated with the patients. Alternatively, both the number of qualified patients that satisfy the performance criterion and the number of qualified patients that do not satisfy the performance criterion may be determined by the compliance module 220 as the compliance index.

The compliance module 220 communicates the compliance indices associated with the healthcare entities 200, 202 to a reporting module 222. The reporting module 222 presents the compliance indices to the healthcare entities 200, 202 in a manner that permits the healthcare entities 200, 202 to compare the compliance indices with each other. The reporting module 222 may instruct the display devices 214, 216 of the healthcare entities 200, 202 to visually display the compliance indices associated with the healthcare entities 200, 202 to users at the healthcare entities 200, 202. The display devices 214, 216 may visually present the compliance indices for all or a subset of the healthcare entities 200, 202 at each of the healthcare entities 200, 202. For example, each healthcare entity 200, 202 may be able to see the compliance index associated with the healthcare entity 200, 202 and the compliance indices of the other healthcare entities 200, 202. The reporting module 222 may direct the display device 214, 216 to print a paper report of the compliance indices, graphically present the compliance indices on a monitor at the healthcare entities 200, 202, and the like. The reporting module 222 also or alternatively may present the compliance indices at the display device 212 of the services comparison system 100.

The reporting module 222 may present the compliance indices to the healthcare entities 200, 202 so that the healthcare entities 200, 202 can determine if a significant number of patients are not being provided with the medical services required or recommended by the performance criteria. For example, the compliance indices may reveal that 80% of the diabetic patients of the healthcare entity 200 are receiving hemoglobin A1c blood tests every three months as recommended by a performance criterion but only 40% of the diabetic patients of the healthcare entity 202 are receiving the hemoglobin A1c blood tests every three months. The reporting module 222 may then recommend a remedial action to the healthcare entity 200 and/or 202 based on the compliance indices. The reporting module 222 may recommend that the healthcare entities 200, 202 provide a new or different medical service or test to the patients as the remedial action.

For example, the reporting module 222 may recommend that the healthcare entity 200 mail or email letters to the 20% of diabetic patients of the healthcare entity 200 and the 60% of the diabetic patients of the healthcare entity 202 that have not received hemoglobin A1c tests within the past 3 months. The reporting module 222 may visually prompt users at the healthcare entities 200, 202 to select a graphic icon presented on the display devices 214, 216 using an input device, such as clicking on a graphical button using an electronic mouse. Selection of the graphic icon may cause the services comparison system 100 and/or the healthcare entities 200, 202 to print and mail or email the letters to the patients of the healthcare entities 200, 202.

In another example, the reporting module 222 may recommend that a patient be examined by another healthcare entity 200, 202. The reporting module 222 may determine that the patient should be examined by a specialist based on the comparison of the performance criterion with the EHR 226 or 228 of the patient. The reporting module 222 may automatically send a notice to the healthcare entity 200, 202 that is recommended. In one embodiment, the healthcare entity 200 (the “recommending healthcare entity 200”) that is recommending that a patient be examined by another healthcare entity 202 (the “recommended healthcare entity 202”) automatically sends the EHR 226 of the patient to the recommended healthcare entity 202. Alternatively, the recommending healthcare entity 200 may grant access to the patient's EHR 226 in the database 230 to the recommended healthcare entity 202. The recommended healthcare entity 202 may then copy the EHR 226 to an EHR 228 stored in the database 232 for the patient.

Different healthcare entities 200, 202 may use different ways to identify patients in the EHRs 226, 228 of the healthcare entities 200, 202. For example, a patient that is treated by both healthcare entities 200, 202 may be associated with different identification numbers by the different healthcare entities 200, 202. The identification numbers may be used to correlate the patient with the correct EHR 226, 228 stored in the databases 230, 232. The reporting module 222 may track the different identification numbers used by the different healthcare entities 200, 202 for the same patient. The reporting module 222 may create a list or database that tracks the patients with the different identification numbers associated with the patients by the healthcare entities 200, 202.

In another embodiment, the compliance indices may reveal that one or more of the healthcare entities 200, 202 are providing unnecessary or excessive services to the patients. For example, the compliance indices may be based on a performance criterion that is established by the health insurance plan 116 (shown in FIG. 1). The health insurance plan 116 may limit the number of medical tests that are covered by a patient's health insurance provided by the health insurance plan 116. The guideline management module 218 may create a performance criterion based on the health insurance provided by the health insurance plan 116. The compliance module 220 may determine the number of patients that are covered by the health insurance and that have received medical services in excess of or that are not covered by the health insurance. This number of patients and/or the excessive or uncovered services may be reported to the healthcare entities 200, 202 by the reporting module 222.

The guidelines or standards upon which the performance criteria are based may be periodically updated. For example, the external guideline administrator 224 may periodically change the guidelines or standards applicable to subsets of the patients receiving medical care from the healthcare entities 200, 202. The guideline management module 218 updates the performance criterion associated with the changed guideline or standard to a modified criterion. The compliance module 220 compares the modified criterion to the EHRs 226, 228 of the healthcare entities 200, 202 to determine adjusted indices for the healthcare entities 200, 202. The adjusted indices are similar to the compliance indices described above. For example, the adjusted indices may represent the number of patients having medical data in the EHRs 226, 228 that satisfies the modified criterion. The reporting module 222 may then present the adjusted indices to the healthcare entities 200, 202.

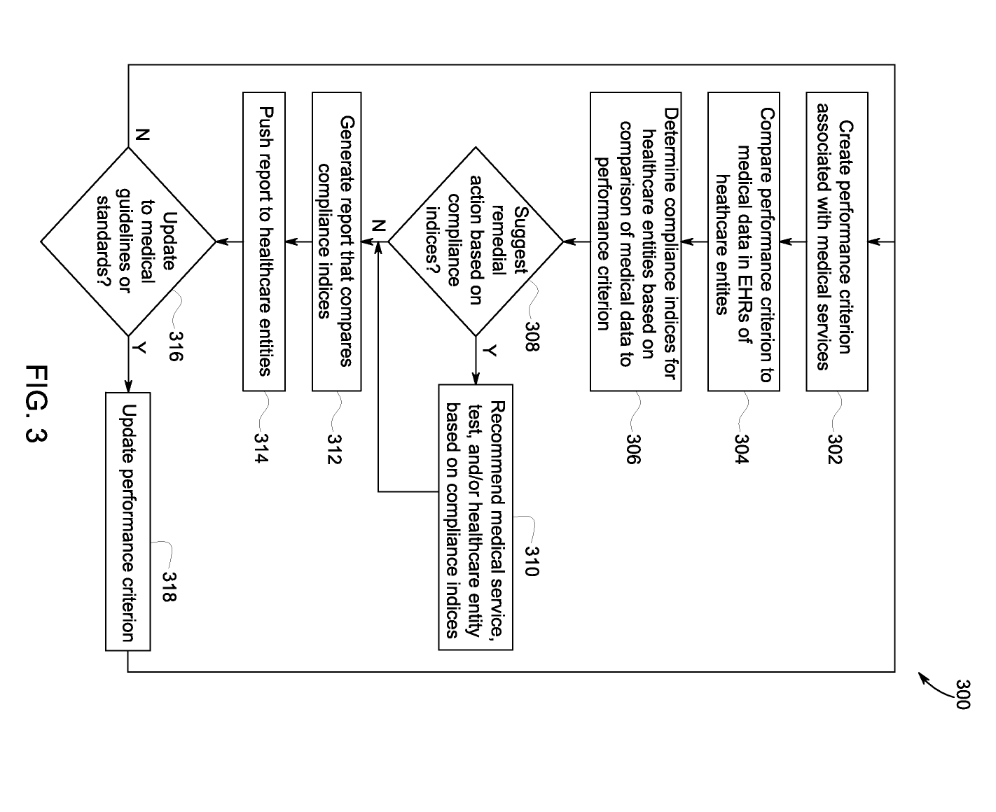

FIG. 3 illustrates a flowchart for a method 300 of comparing medical services provided by different healthcare entities 200, 202 (shown in FIG. 2) in accordance with one embodiment. At 302, a performance criterion is created that is associated with medical services. For example, a performance criterion may be created based on medical guidelines or standards.

At 304, the performance criterion is compared to medical data of patients that is stored in EHRs 226, 228 (shown in FIG. 2) of different healthcare entities 200, 202 (shown in FIG. 2).

At 306, compliance indices are determined for the different healthcare entities 200, 202 (shown in FIG. 2) based on the comparison of the performance criterion to the medical data of the EHRs 226, 228 (shown in FIG. 2). In one embodiment, the compliance indices are calculated using a processor, such as a computer processor, microprocessor, controller, microcontroller, or some other logic device.

At 308, a determination is made as to whether a remedial action should be recommended based on the compliance indices. A decision may be made as to whether the compliance indices indicate that one or more additional or different medical services or tests should be provided to one or more patients of the healthcare entities 200, 202 (shown in FIG. 2). For example, the performance criterion may recommend that all patients aged 50 years and older receive a blood glucose test at least once a year and, if the results of the blood glucose test exceed a predetermined threshold, then (1) a hemoglobin A1c test should be administered and (2) the patients should consult an endocrinologist to determine if the patients are diabetic. If the compliance indices demonstrate that several qualified patients are not receiving the blood glucose tests per the performance criterion, then the compliance indices may indicate that the patients should receive blood glucose tests. As another example, if the compliance indices demonstrate that several qualified patients are receiving the blood glucose tests and that the results of the blood glucose tests are relatively high, then the compliance indices may indicate that the patients should be administered hemoglobin A1c tests and be referred to endocrinologists for examinations. In one embodiment, the determination of whether a remedial action should be recommended is performed by a processor, such as a computer processor, microprocessor, controller, microcontroller, or some other logic device.

If the compliance indices indicate that a remedial action should be recommended, then flow of the method 300 proceeds to 310. Otherwise, flow of the method 300 proceeds to 312.

At 310, a remedial action is recommended to be provided by one or more of the healthcare entities 200, 202 (shown in FIG. 2). In one embodiment, an additional or different medical service or medical test may be recommended to be provided by the healthcare entities 200, 202 to one or more patients based on the compliance indices. A referral to another healthcare entity 200, 202 may be recommended. In continuing with the above example, if the compliance indices demonstrate that several qualified patients are not receiving the blood glucose tests per the performance criterion, then the remedial action may be to recommend that the blood glucose tests be administered to the patients. If the compliance indices demonstrate that several qualified patients are receiving the blood glucose tests and that the results of the blood glucose tests are relatively high, then the remedial action may be to administer hemoglobin A1c tests to the patients and be refer the patients to endocrinologists for examinations.

At 312, a report that presents the compliance indices is generated. The report may visually compare the compliance indices of different healthcare entities 200, 202 (shown in FIG. 2) so that the healthcare entities 200, 202 may readily determine how closely the healthcare entities 200, 202 are following medical guidelines or standards relative to other healthcare entities 200, 202.

At 314, the report is pushed to the healthcare entities 200, 202 (shown in FIG. 2). For example, the report may be automatically generated and communicated to the display devices 214, 216 (shown in FIG. 2) of the healthcare entities 200, 202 so that the healthcare entities 200, 202 may compare the compliance indices. Alternatively, the report may be retrieved by the healthcare entities 200, 202 from the services comparison system 100 (shown in FIG. 1).

At 316, a determination is made as to whether the medical guidelines or standards upon which the performance criterion is based have been updated since the performance criterion was created. If the medical guidelines or standards have been updated, then the performance criterion may need to be updated. As a result, flow of the method 300 proceeds to 318. Conversely, if the medical guidelines or standards have not been updated, then the performance criterion may not need to be updated and flow of the method 300 returns to 302. The method 300 may return to 302 so that additional compliance indices may be periodically generated for the healthcare entities 200, 202 (shown in FIG. 2).

At 318, the performance criterion is updated based on the change to the medical guidelines or standards upon which the performance criterion is based. The performance criterion may be updated to a modified criterion. Flow of the method 300 returns to 302 where additional compliance indices are generated based on the modified criterion. These additional compliance indices may be referred to as adjusted indices.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for comparing medical services provided by a plurality of healthcare entities, the method comprising:
creating a performance criterion that is associated with the medical services provided to patients by first and second healthcare entities;
using a processor to determine first and second compliance indices by comparing the performance criterion to first and second sets of electronic health records (EHRs) of the patients that are maintained by the first and second healthcare entities, respectively, the first and second compliance indices representing quantities of the patients having medical data in the first and second sets of EHRs that satisfy the performance criterion; and
presenting the first and second compliance indices associated with the first and second healthcare entities to a user.

2. The method of claim 1, further comprising: updating the performance criterion to a modified criterion that differs from the performance criterion, updating the first and second compliance indices to first and second adjusted indices by comparing the modified criterion to the first and second sets of EHRs, and presenting the first and second adjusted indices to the user.

3. The method of claim 2, wherein updating the performance criterion is performed remotely from the first and second healthcare entities.

4. The method of claim 1, wherein presenting includes generating a report that visually provides a comparison of the first and second compliance indices with each other.

5. The method of claim 1, wherein the first and second healthcare entities are at least one of different physicians, different physician associations, different physician practice groups, or different hospitals.

6. The method of claim 1, wherein creating the performance criterion is performed remotely from the first and second healthcare entities.

7. The method of claim 1, further comprising recommending at least one of a new medical service, one or more of the medical services provided by the first or second healthcare entities, or a medical test to at least one of the patients based on one or more of the first or second compliance indices.

8. The method of claim 1, wherein the performance criterion represents at least one of a frequency at which at least one of a medical test is applied to the patients, a frequency at which one or more of the medical services is provided to the patients, or a result of the medical test applied to the patients.

9. The method of claim 1, wherein the first and second sets of EHRs include the medical data indicative of at least one of a frequency at which at least one of a medical test is applied to the patients, a frequency at which at which one or more of the medical services is provided to the patients, or a result of the medical test applied to the patients.

10. A system for comparing medical services provided by a plurality of healthcare entities, the system comprising:
a guideline management module creating a performance criterion that is associated with the medical services provided to patients by first and second healthcare entities;
a compliance module receiving the performance criterion from the guideline management module, the compliance module determining first and second compliance indices by comparing the performance criterion to first and second sets of electronic health records (EHRs) of the patients that are maintained by the first and second healthcare entities, respectively, the first and second compliance indices representing quantities of the patients having medical data in the first and second sets of EHRs that satisfies the performance criterion; and
a reporting module receiving the first and second compliance indices associated with the first and second healthcare entities from the compliance module and presenting the first and second compliance indices to a user.

11. The system of claim 10, wherein the guideline management module updates the performance criterion to a modified criterion that differs from the performance criterion, the compliance module receives the modified criterion and updates the first and second compliance indices to first and second adjusted indices by comparing the modified criterion to the first and second sets of EHRs, and the reporting module receives the first and second adjusted indices to present the first and second adjusted indices to the user.

12. The system of claim 10, wherein the reporting module generates a report that visually compares the first and second compliance indices with each other.

13. The system of claim 10, wherein the first and second healthcare entities are at least one of different physicians, different physician associations, different physician practice groups, or different hospitals.

14. The system of claim 10, wherein the reporting module recommends at least one of a new medical service, one or more of the medical services provided by the first or second healthcare entities, or a medical test to at least one of the patients based on one or more of the first or second compliance indices.

15. The system of claim 10, wherein the performance criterion represents at least one of a frequency at which at least one of a medical test is applied to the patients, a frequency at which at which one or more of the medical services is provided to the patients, or a result of the medical test applied to the patients.

16. A tangible and non-transitory computer readable storage medium for a system that compares medical services provided by a plurality of healthcare entities, the computer readable storage medium including instructions to direct a processor of the system to:
create a performance criterion that is associated with the medical services provided to patients by first and second healthcare entities;
determine first and second compliance indices by comparing the performance criterion to first and second sets of electronic health records (EHRs) of the patients that are maintained by the first and second healthcare entities, respectively, the first and second compliance indices representing quantities of the patients having medical data in the first and second sets of EHRs that satisfies the performance criterion; and
present the first and second compliance indices to a user.

17. The computer readable storage medium of claim 16, wherein the instructions direct the processor to update the performance criterion to a modified criterion that differs from the performance criterion, update the first and second compliance indices to first and second adjusted indices by comparing the modified criterion to the first and second sets of EHRs, and present the first and second adjusted indices to the user.

18. The computer readable storage medium of claim 16, wherein the instructions direct the processor to recommend at least one of a new medical service, one or more of the medical services provided by the first or second healthcare entities, or a medical test to at least one of the patients based on one or more of the first or second compliance indices.

19. The computer readable storage medium of claim 16, wherein the performance criterion represents at least one of a frequency at which at least one of a medical test is applied to the patients, a frequency at which at which one or more of the medical services is provided to the patients, or a result of the medical test applied to the patients.

20. The computer readable storage medium of claim 16, wherein the first and second sets of EHRs include the medical data indicative of at least one of a frequency at which at least one of a medical test is applied to the patients, a frequency at which at which one or more of the medical services is provided to the patients, or a result of the medical test applied to the patients.
